(19) United States
(12) Patent Application Publication
(10) Pub. No.: US 2024/0107636 A1
(43) Pub. Date: Mar. 28, 2024

(54) HEATING COOKING APPARATUS

(71) Applicant: SHARP KABUSHIKI KAISHA, Sakai City, Osaka (JP)

(72) Inventors: YU SHINOHARA, Sakai City, Osaka (JP); MASAHIRO NISHIJIMA, Sakai City, Osaka (JP)

(73) Assignee: SHARP KABUSHIKI KAISHA, Sakai City, Osaka (JP)

(21) Appl. No.: 18/266,539

(22) PCT Filed: Dec. 7, 2021
(86) PCT No.: PCT/JP2021/044883

§ 371 Date: Jun. 9, 2023

(30) Foreign Application Priority Data
Dec. 10, 2020 (JP) 2020-205004

(51) Int. Cl. H05B 6/64; F24C 15/16

(52) U.S. Cl. CPC H05B 6/6414; F24C 15/162; H05B 6/642

(57) ABSTRACT

A heating cooking apparatus includes a heating cooking chamber, a housing, a lid portion, a first circulation portion, a first blow-out port, and a guide portion. The heating cooking chamber further includes an opening. The housing accommodates the heating cooking chamber. The lid portion opens and closes the opening. The first circulation portion causes first air to circulate between an upper wall of the heating cooking chamber and an upper wall of the housing. When the lid portion opens the opening, the guide portion guides the first air blown out from the first blow-out port toward the opening.

### TECHNICAL FIELD

The present invention relates to a heating cooking apparatus.

### BACKGROUND ART

A heating cooking apparatus including a heating cooking chamber and a pull-out body is known. The pull-out body is integrated with an opening/closing door. The pull-out body is disposed such that the pull-out body can be pulled out from the heating cooking chamber. Such a heating cooking apparatus as described above is built into a cabinet of a built-in kitchen.

PTL 1 discloses a heating cooking apparatus. Heating functions of the heating cooking apparatus disclosed in PTL 1 include a microwave heating function and a high-speed hot air heating function. The microwave heating function is a function of irradiating an object to be heated with microwaves. The high-speed hot air heating function is a function of blowing out hot air at high speed toward an object to be heated.

### CITATION LIST

### Patent Literature

PTL 1: JP 2010-133634 A

### SUMMARY OF INVENTION

### Technical Problem

However, in the heating cooking apparatus disclosed in PTL 1, when an opening of a heating cooking chamber is opened, relatively warm air flows out from the heating cooking chamber. As a result, when the air flows out toward a user who has opened the opening of the heating cooking chamber, the user may experience this as unpleasant.

In light of the problem described above, an object of the present invention is to provide a heating cooking apparatus that can inhibit air from the interior of a heating cooking chamber from flowing out in the upward direction when an opening of the heating cooking chamber is opened.

### Solution to Problem

According to an aspect of the present invention, a heating cooking apparatus includes a heating cooking chamber, a housing, a lid portion, a first circulation portion, a first blow-out port, and a guide portion. The heating cooking chamber includes an opening. The housing accommodates the heating cooking chamber. The lid portion opens and closes the opening. The first circulation portion causes first air to circulate between an upper wall of the heating cooking chamber and an upper wall of the housing. The first air is blown out from the first blow-out port. The guide portion guides, toward the opening, the first air blown out from the first blow-out port when the lid portion opens the opening.

### Advantageous Effects of Invention

According to a heating cooking apparatus of the present invention, it is possible to inhibit air from the interior of a heating cooking chamber from flowing out in the upward direction when an opening of the heating cooking chamber is opened.

### BRIEF DESCRIPTION OF DRAWINGS

FIG. 1 is a perspective view illustrating a pull-out type heating cooking apparatus according to an embodiment of the present invention.

FIG. 2 is a right side surface view illustrating the pull-out type heating cooking apparatus according to the present embodiment.

FIG. 3 is a top view illustrating the pull-out type heating cooking apparatus according to the present embodiment.

FIG. 4 is a perspective view illustrating the pull-out type heating cooking apparatus according to the present embodiment.

FIG. 5 is a cross-sectional view of a heating chamber taken along a plane orthogonal to a third direction in the pull-out type heating cooking apparatus according to the present embodiment.

FIG. 6 is a front view of the pull-out type heating cooking apparatus according to the present embodiment.

FIG. 7 is a front view of the pull-out type heating cooking apparatus according to the present embodiment.

FIG. 8 is a cross-sectional view of the pull-out type heating cooking apparatus according to the present embodiment.

FIG. 9 is an enlarged view of the pull-out type heating cooking apparatus according to the present embodiment.

FIG. 10 is a cross-sectional view of the pull-out type heating cooking apparatus taken along a section line X in FIG. 4.

FIG. 11 is a block diagram illustrating a configuration of the pull-out type heating cooking apparatus according to the present embodiment.

FIG. 12 is a perspective view illustrating a cabinet to which the pull-out type heating cooking apparatus according to the present embodiment is attached.

### DESCRIPTION OF EMBODIMENTS

Hereinafter, embodiments of a pull-out type heating cooking apparatus according to the present invention will be described with reference to the drawings. Note that, in the drawings, the same or equivalent components are denoted by the same reference numerals and signs, and description thereof will not be repeated.

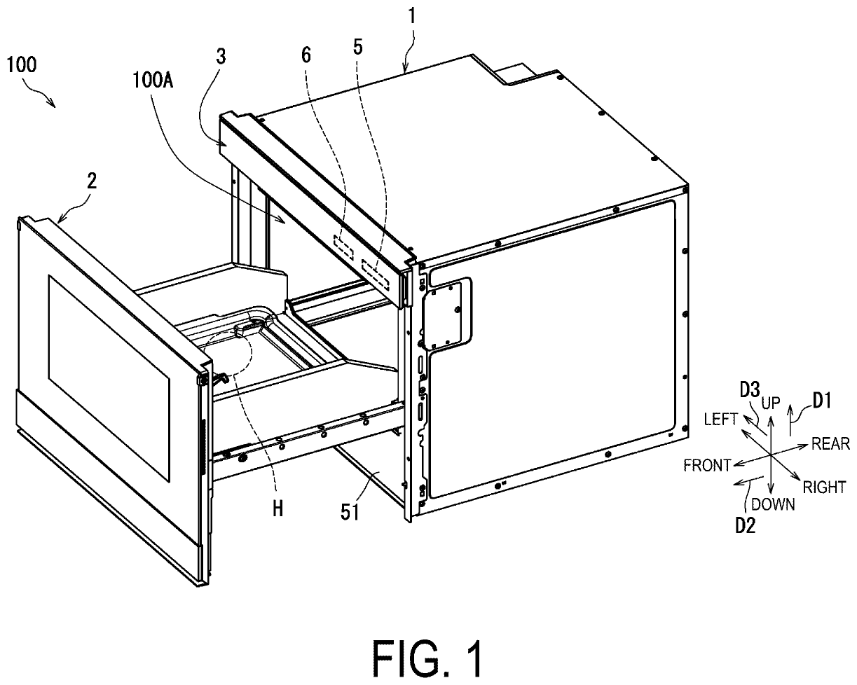

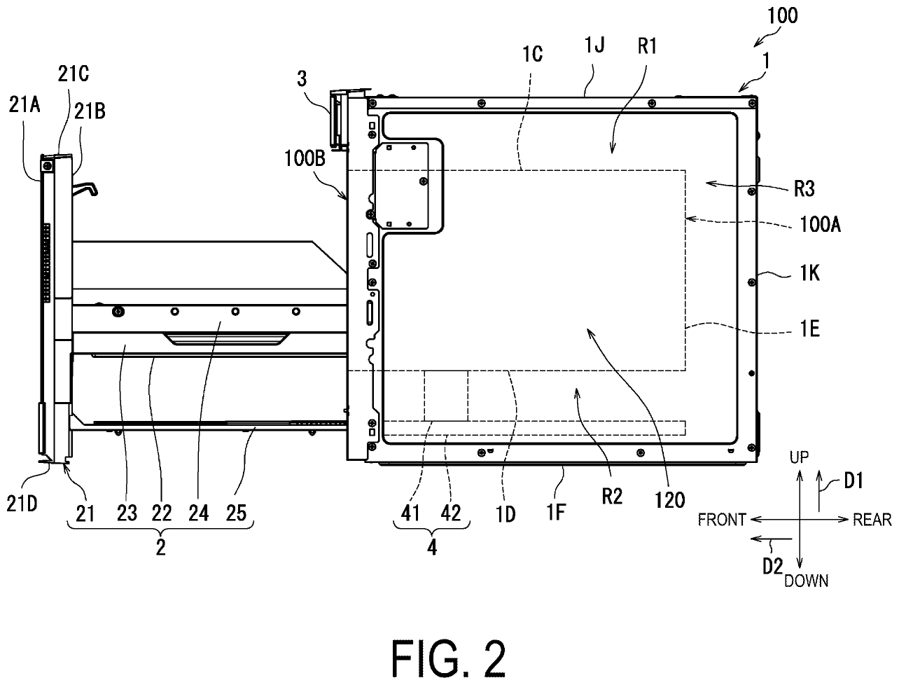

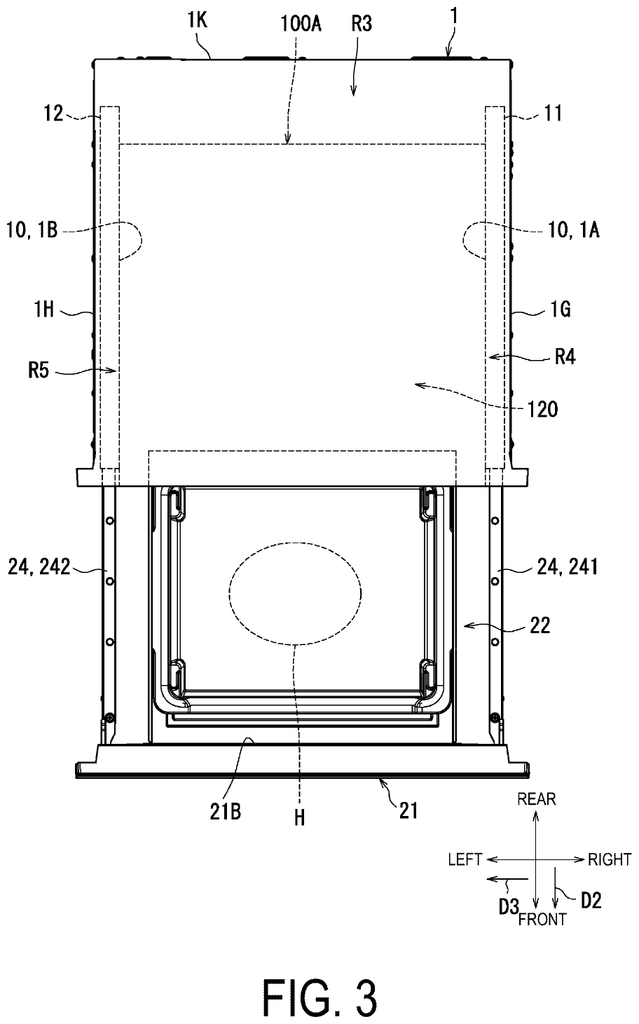

A pull-out type heating cooking apparatus 100 according to the present embodiment will be described with reference to FIG. 1 to FIG. 3. FIG. 1 is a perspective view illustrating the pull-out type heating cooking apparatus 100. FIG. 2 is a right side surface view illustrating the pull-out type heating cooking apparatus 100. FIG. 3 is a top view illustrating the pull-out type heating cooking apparatus 100. More specifically, FIG. 1 to FIG. 3 illustrate the pull-out type heating cooking apparatus 100 in a state where a pull-out body 2 is pulled out. Further, FIG. 1 illustrates an external appearance of the pull-out type heating cooking apparatus 100 as viewed diagonally from the upper front right. The pull-out type heating cooking apparatus 100 is an example of a heating cooking apparatus.

As illustrated in FIG. 1, the pull-out type heating cooking apparatus 100 heats and cooks an object H to be heated. The object H to be heated is, for example, a food product. The pull-out type heating cooking apparatus 100 includes a heating chamber 1, the pull-out body 2, an operation panel 3, a heating cooking chamber 100A, and a panel 51. The heating chamber 1 is an example of a “housing”. The operation panel 3 is an example of an “operation unit”.

In the present embodiment, a side at which the operation panel 3 of the pull-out type heating cooking apparatus 100 is disposed is defined as a front side of the pull-out type heating cooking apparatus 100, and a side opposite to the front side (rear face side) is defined as a rear side of the pull-out type heating cooking apparatus 100. Further, a right side when the pull-out type heating cooking apparatus 100 is viewed from the front side is defined as a right side of the pull-out type heating cooking apparatus 100, and a side opposite to the right side is defined as a left side of the pull-out type heating cooking apparatus 100. Further, in a direction orthogonal to a front-rear direction and a right-left direction of the pull-out type heating cooking apparatus 100, a side at which the operation panel 3 is disposed is defined as an upper side of the pull-out type heating cooking apparatus 100, and a side opposite to the upper side (bottom side) is defined as a lower side of the pull-out type heating cooking apparatus 100. Note that these orientations do not limit an orientation of the pull-out type heating cooking apparatus 100 according to the present invention in use. In the present embodiment, a first direction D1 is the upward direction.

As illustrated in FIG. 1 to FIG. 3, the heating chamber 1 is a box-like member. Specifically, the heating chamber 1 includes a right outer wall 1G, a left outer wall 1H, a top outer wall 1J, a bottom outer wall 1F, and a back outer wall 1K. Then, the heating chamber 1 accommodates the heating cooking chamber 100A.

The pull-out body 2 moves along a second direction D2 with respect to the heating cooking chamber 100A. The second direction D2 is an example of a “specific direction”. The second direction D2 intersects the first direction D1. In the present embodiment, the second direction D2 is orthogonal to the first direction D1. The second direction D2 is the forward direction. Specifically, the pull-out body 2 can be pulled out from the heating cooking chamber 100A along a second direction D2.

The heating cooking chamber 100A includes a placing space 120 that accommodates the object H to be heated. The shape of the heating cooking chamber 100A is, for example, a substantially rectangular parallelepiped shape. Specifically, the heating cooking chamber 100A includes a pair of side wall portions 10, a back wall 1E, and an opening portion 100B. The opening portion 100B is an example of an “opening”. The back wall 1E intersects the second direction D2. The opening portion 100B faces the back wall 1E. The opening portion 100B opens toward the second direction D2. The opening portion 100B communicates with the outside of the heating cooking chamber 100A. The pair of side wall portions 10 face each other in a third direction D3. The third direction D3 is the leftward direction. Specifically, the pair of side wall portions 10 include a right wall 1A and a left wall 1B. The heating cooking chamber 100A further includes a top wall 1C and a bottom wall 1D. Materials of the right wall 1A, the left wall 1B, the top wall 1C, the bottom wall 1D, and the back wall 1E are, for example, a metal.

The pull-out type heating cooking apparatus 100 further includes a first space R1, a second space R2, a third space R3, a fourth space R4, and a fifth space R5. The first space R1 is an example of a “first circulation portion”.

The first space R1 is disposed between the top wall 1C and the top outer wall 1J. The second space R2 is disposed between the bottom wall 1D and the bottom outer wall 1F. The third space R3 is disposed between the back wall 1E and the back outer wall 1K. The fourth space R4 is disposed between the right wall 1A and the right outer wall 1G. The fifth space R5 is disposed between the left wall 1B and the left outer wall 1H.

The panel 51 is a plate-like member having a rectangular ring shape. The panel 51 is disposed at the outer periphery of the opening portion 100B, inside the heating chamber 1.

The operation panel 3 receives an operation from a user. The operation includes, for example, a cooking method for heating and cooking the object H to be heated, or information about movement of a lid portion 21 between a closed position and an open position thereof. Specifically, the operation panel 3 includes a display unit, a storage unit 6, and a control unit 5. The display unit displays various pieces of information. Specifically, the display unit includes a liquid crystal panel.

The storage unit 6 is constituted by a Random Access Memory (RAM) and a Read Only Memory (ROM). The storage unit 6 stores a control program for controlling an operation of each unit of the pull-out type heating cooking apparatus 100. The storage unit 6 stores setting information that is input by operating the display unit.

The control unit 5 is a hardware circuit that includes a processor such as a Central Processing Unit (CPU). The control unit 5 executes the control program stored in the storage unit 6.

Once again, as illustrated in FIG. 2 and FIG. 3, the pull-out body 2 includes the lid portion 21, a placing portion 22, and a support portion 23.

The lid portion 21 opens and closes the opening portion 100B on the front side of the heating cooking chamber 100A. The lid portion 21 is a substantially rectangular plate-like member. The lid portion 21 includes a front surface 21A, a rear surface 21B, an upper surface 21C, and a lower surface 21D. The lid portion 21 causes the opening portion 100B on the front side of the heating cooking chamber 100A to be open in a state where the pull-out body 2 is pulled out from the heating cooking chamber 100A. The lid portion 21 closes the opening portion 100B on the front side of the heating cooking chamber 100A in a state where the pull-out body 2 is retracted into the heating cooking chamber 100A.

The object H to be heated can be placed on the placing portion 22. Specifically, the placing portion 22 has a placing surface on which the object H to be heated is placed. The material of the placing portion 22 is a non-metal, and is preferably ceramic or glass, for example. As a result, the placing portion 22 transmits microwaves.

The support portion 23 is fixed to the rear surface 21B of the lid portion 21 and supports a peripheral edge portion of the placing portion 22 such that the placing portion 22 is held in a horizontal state. The material of the support portion 23 is, for example, a metal.

Then, the placing portion 22 and the support portion 23 are pulled out from the inside of the heating cooking chamber 100A to the outside by the pull-out body 2 being pulled out. The placing portion 22 and the support portion 23 are accommodated in the heating cooking chamber 100A in a state where the pull-out body 2 is retracted.

The pull-out body 2 further includes a pair of slide members 24 and a support member 25. The support member 25 is an example of a “moving member”. The pair of slide members 24 extend in the front-rear direction and define the movement direction of the pull-out body 2. The pair of slide members 24 are fixed to the rear surface 21B of the lid portion 21. Specifically, one slide member of the pair of slide members 24 includes a right side slide member 241, and the other slide member of the pair of slide members 24 includes a left side slide member 242. Each of the right side slide member 241 and the left side slide member 242 is, for example, a member having the front-rear direction as a longitudinal direction. The right side slide member 241 and the left side slide member 242 face each other in the right-left direction. One end portion of the right side slide member 241 is attached to a right edge portion of the rear surface 21B of the lid portion 21. One end portion of the left side slide member 242 is attached to a left edge portion of the rear surface 21B of the lid portion 21.

Meanwhile, the heating chamber 1 further includes a right side slide rail 11 and a left side slide rail 12. The right side slide rail 11 is fixed to the right wall 1A in the fourth space R4 between the right wall 1A and the right outer wall 1G. The left side slide rail 12 is fixed to the left wall 1B in the fifth space R5 between the left wall 1B and the left outer wall 1H. Each of the right side slide rail 11 and the left side slide rail 12 is a member having the front-rear direction as a longitudinal direction. The right side slide member 241 is slidably supported by the right side slide rail 11. The left side slide member 242 is slidably supported by the left side slide rail 12.

The support member 25 supports the lid portion 21. More specifically, the lid portion 21 is fixed to the support member 25 so as to be substantially perpendicular to the second direction D2. The support member 25 extends in the direction opposite to the second direction D2, and defines the movement direction of the pull-out body 2. One end portion of the support member 25 is attached at a center portion in the right-left direction of the rear surface 21B of the lid portion 21 and below the placing portion 22. The support member 25 is, for example, a plate-like member having the front-rear direction as a longitudinal direction. The support member 25 includes a rack portion. The rack portion includes teeth. The support member 25 may be a single plate-like member or a plurality of plate-like members.

Meanwhile, the heating chamber 1 further includes a drive mechanism 4. The drive mechanism 4 drives the support member 25. Then, the drive mechanism 4 is positioned below the heating cooking chamber 100A. Specifically, the drive mechanism 4 is accommodated in the second space R2 between the bottom wall 1D and the bottom outer wall 1F. For example, the drive mechanism 4 includes a drive motor 41, a pinion, and a drive rail 42. The drive rail 42 is fixed in the second space R2 between the bottom wall 1D and the bottom outer wall 1F. The drive rail 42 is a member having the front-rear direction as a longitudinal direction. The support member 25 is slidably supported by the drive rail 42. The pinion is attached to an endmost portion of the drive motor 41. The pinion engages with the rack portion of the support member 25. Furthermore, the support member 25 moves in the front-rear direction as a result of rotation of the pinion. Note that the drive mechanism 4 may drive at least one of the support member 25, the right side slide member 241, and the left side slide member 242. Further, in a case where the right side slide member 241 and the left side slide member 242 are driven, the drive mechanism 4 may be positioned on the side of the heating cooking chamber 100A.

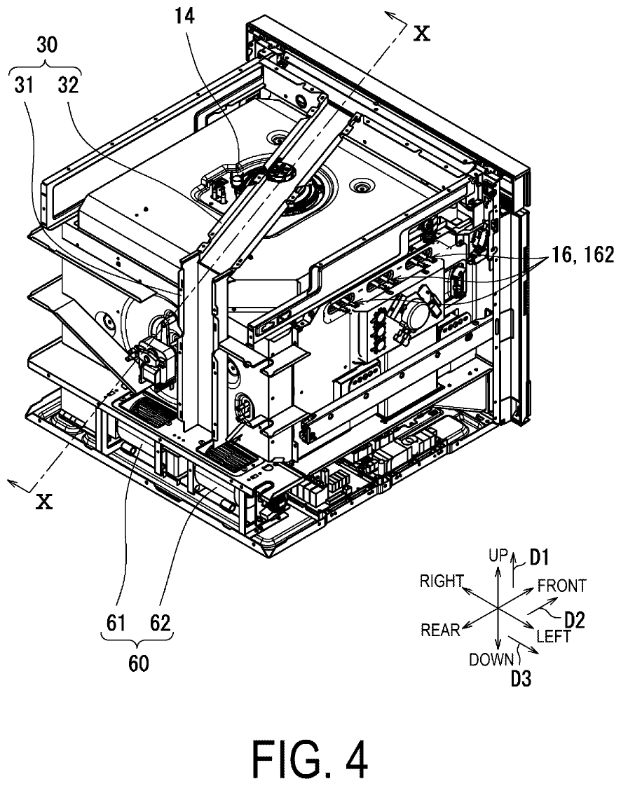

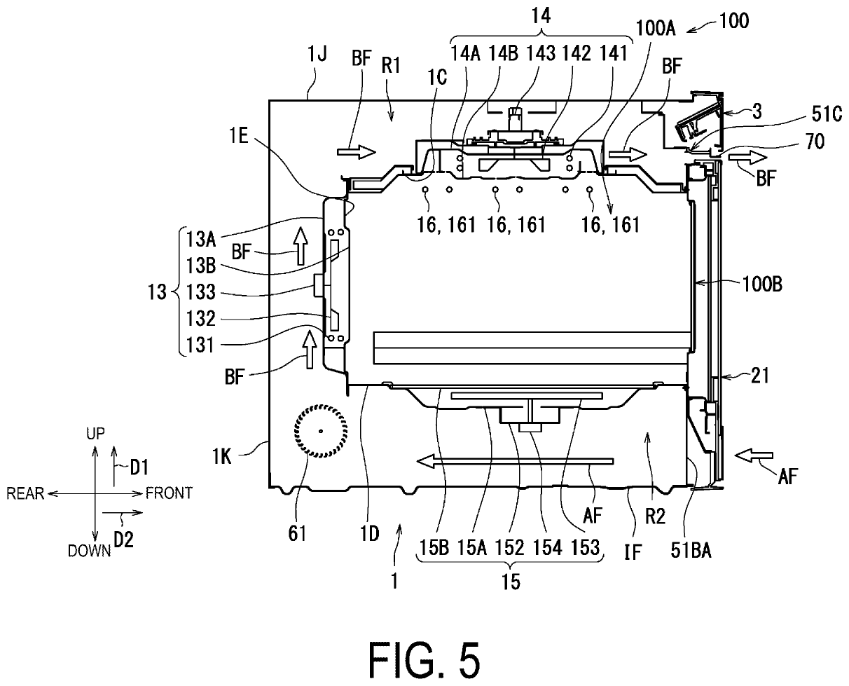

Next, the heating chamber 1 will be further described with reference to FIG. 4 and FIG. 5. FIG. 4 is a perspective view illustrating the pull-out type heating cooking apparatus 100. More specifically, FIG. 4 illustrates an external appearance of the pull-out type heating cooking apparatus 100 as viewed from above and diagonally from the rear left. Note that FIG. 4 is a perspective view illustrating the pull-out type heating cooking apparatus 100 from which the left outer wall 1H, the top outer wall 1J, and the back outer wall 1K are removed. Further, FIG. 5 is a schematic cross-sectional view of the heating chamber 1. More specifically, FIG. 5 is a cross-sectional view of the heating chamber 1 taken along a plane orthogonal to the third direction D3.

As illustrated in FIG. 4 and FIG. 5, the pull-out type heating cooking apparatus 100 includes a microwave supply unit 15, a first air sending unit 13, a second air sending unit 14. Each of the microwave supply unit 15, the first air sending unit 13, and the second air sending unit 14 is an example of a “heating unit”. Each of the microwave supply unit 15, the first air sending unit 13, and the second air sending unit 14 heats the object H to be heated.

First, the microwave supply unit 15 will be described. The microwave supply unit 15 supplies microwaves into the heating cooking chamber 100A.

The microwave supply unit 15 is positioned below the heating cooking chamber 100A. Specifically, the microwave supply unit 15 is positioned outside the heating cooking chamber 100A via the bottom wall 1D. The microwave supply unit 15 includes a partitioning member 15B, a radiation chamber 15A, a magnetron 151, a waveguide 152, a rotary antenna 153, and an antenna motor 154. The magnetron 151 generates microwaves. The waveguide 152 propagates the microwaves generated by the magnetron 151 to the radiation chamber 15A.

The rotary antenna 153 is accommodated in the radiation chamber 15A. The antenna motor 154 drives the rotary antenna 153. The rotary antenna 153 agitates microwaves and supplies the microwaves into the heating cooking chamber 100A.

The partitioning member 15B is positioned above the radiation chamber 15A and below the heating cooking chamber 100A. The material of the partitioning member 15B is a non-metal, and includes ceramic or glass, for example. As a result of the material of the partitioning member 15B including the ceramic or glass, the partitioning member 15B transmits microwaves. On the other hand, the material of each of the radiation chamber 15A and the waveguide 152 includes a metal.

Next, the first air sending unit 13 will be described. The first air sending unit 13 supplies hot air into the heating cooking chamber 100A. The first air sending unit 13 is disposed at the back wall 1E. More specifically, the first air sending unit 13 is positioned behind the heating cooking chamber 100A via the back wall 1E.

Specifically, the first air sending unit 13 further includes an air sending chamber 13A, a heater 131, a centrifugal fan 132, a drive unit 133, and a partitioning member 13B. The heater 131 is an example of a “heating element”. The drive unit 133 is an example of a “contributing portion”. The drive unit contributes to the “heating element” by driving the centrifugal fan and sending air to the heater. The air sending chamber 13A is, for example, a box-like member. The centrifugal fan 132 includes a plurality of blades.

The heater 131 and the centrifugal fan 132 are accommodated in the air sending chamber 13A. The heater 131 heats the air inside the air sending chamber 13A to generate hot air. Specifically, the shape of the heater 131 is a circular ring shape when viewed from the front side to the rear side. Further, the heater 131 is disposed along the outer circumference of the centrifugal fan 132.

The drive unit 133 is positioned outside the air sending chamber 13A. The drive unit 133 contributes to the heater 131. Specifically, the drive unit 133 energizes the heater 131, and also drives the centrifugal fan 132. The drive unit 133 includes, for example, a motor and an energization unit.

The partition member 13B is positioned behind the placing space 120. Specifically, the partitioning member 13B is positioned between the air sending chamber 13A and the heating cooking chamber 100A. The partitioning member 13B is, for example, a plate-like member made of a metal. The shape of the partitioning member 13B is, for example, a rectangular shape when viewed from the front side to the rear side. The partitioning member 13B is disposed over a substantially entire surface of the back wall 1E.

The partitioning member 13B includes a suction hole portion and a blow-out hole portion. More specifically, the suction hole portion is, for example, a set of a plurality of punched holes. Similarly, the blow-out hole portion is also, for example, a set of a plurality of punched holes. Each of the punched holes has, for example, a circular shape. The diameter of each of the punched holes of the suction hole portion and the blow-out hole portions is, for example, 3.4 mm to prevent microwaves from leaking.

The first air sending unit 13 sucks the hot air in the heating cooking chamber 100A through the suction hole portion, and blows out the hot air into the heating cooking chamber 100A through the blow-out hole portion. More specifically, the first air sending unit 13 sucks the hot air from a center portion in the heating cooking chamber 100A, and blows out the hot air to a peripheral edge portion in the heating cooking chamber 100A. As a result, the entire space in the heating cooking chamber 100A can be heated by driving the first air sending unit 13.

Next, the second air sending unit 14 will be described. The second air sending unit 14 supplies hot air into the heating cooking chamber 100A. The second air sending unit 14 is disposed at the top wall 1C. More specifically, the second air sending unit 14 is positioned above the heating cooking chamber 100A via the top wall 1C.

Specifically, the second air sending unit 14 further includes an air sending chamber 14A, a heater 141, a centrifugal fan 142, a drive unit 143, and a partitioning member 14B. The heater 141 is an example of the “heating element”. The drive unit 143 is an example of the “contributing portion”. The drive unit contributes to the “heating element” by driving the centrifugal fan and sending air to the heater. The air sending chamber 14A is, for example, a box-like member. The centrifugal fan 142 includes a plurality of blades.

The heater 141 and the centrifugal fan 142 are accommodated in the air sending chamber 14A. The heater 141 heats air inside the air sending chamber 14A to generate hot air. Specifically, the shape of the heater 141 is a circular ring shape when viewed from the upper side to the lower side. Further, the heater 141 is disposed along the outer circumference of the centrifugal fan 142.

The drive unit 143 is positioned outside the air sending chamber 14A. The drive unit 143 contributes to the heater 141. Specifically, the drive unit 143 energizes the heater 141, and also drives the centrifugal fan 142. The drive unit 143 includes, for example, a motor and an energization unit.

The partition member 14B is positioned above the placing space 120. Specifically, the partitioning member 14B is positioned between the air sending chamber 14A and the heating cooking chamber 100A. The partitioning member 14B is, for example, a plate-like member made of a metal. The shape of the partitioning member 14B is, for example, a rectangular shape when viewed from the upper side to the lower side. The partitioning member 14B is disposed in a center portion of the top wall 1C.

The partitioning member 14B includes a suction hole portion and a blow-out hole portion. More specifically, the suction hole portion is, for example, a set of a plurality of punched holes. Similarly, the blow-out hole portion is also, for example, a set of a plurality of punched holes. Each of the punched holes has, for example, a circular shape. The diameter of each of the punched holes of the suction hole portion and the blow-out hole portions is, for example, 3.4 mm to prevent microwaves from leaking.

The second air sending unit 14 sucks the hot air in the heating cooking chamber 100A through the suction hole portion, and blows out the hot air into the heating cooking chamber 100A through the blow-out hole portion. More specifically, the second air sending unit 14 sucks the hot air from the center portion in the heating cooking chamber 100A, and blows out the hot air to the peripheral edge portion in the heating cooking chamber 100A.

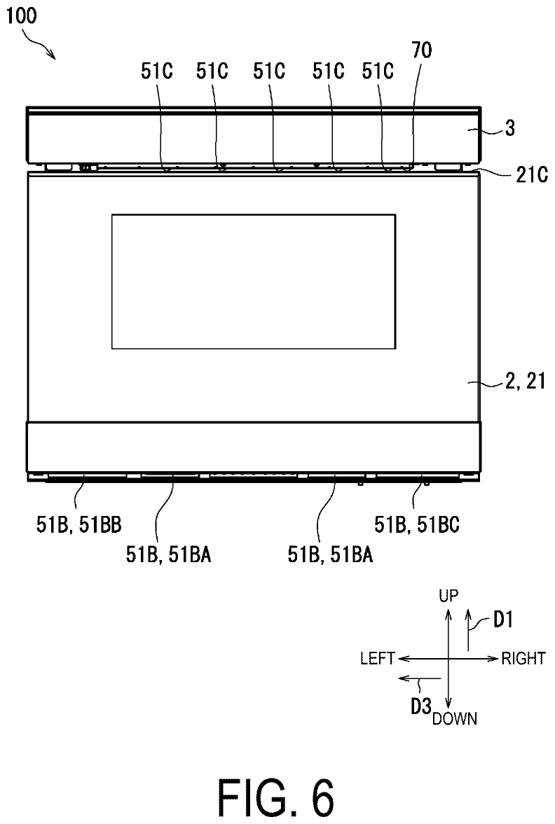

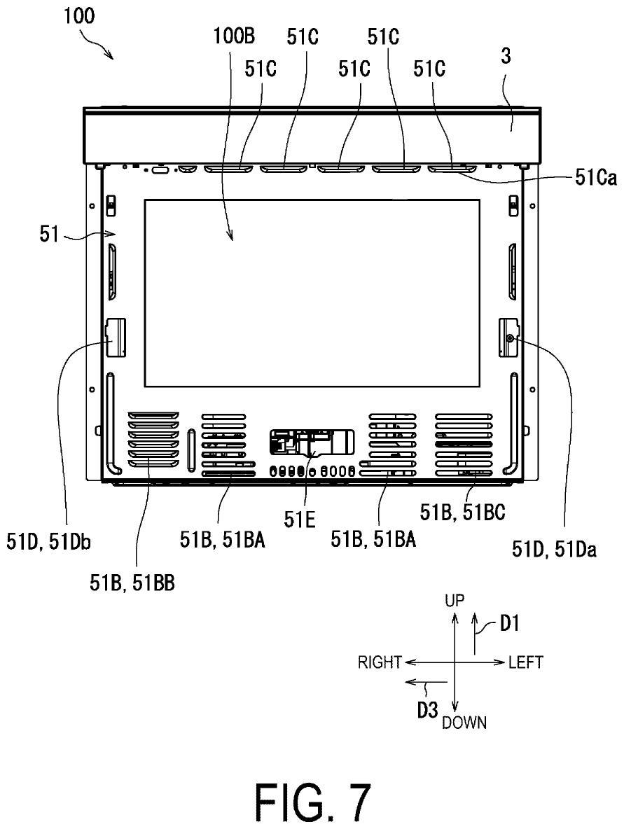

Next, the panel 51 will be further described with reference to FIG. 6 and FIG. 7. FIG. 6 and FIG. 7 are front views of the pull-out type heating cooking apparatus 100 according to the present embodiment. More specifically, FIG. 7 illustrates the pull-out type heating cooking apparatus 100 from which the pull-out body 2 and a guide portion 70 described later are removed.

As illustrated in FIG. 6 and FIG. 7, the panel 51 includes a plurality of first through hole portions 51B, a plurality of second through hole portions 51C, a pair of third through hole portions 51D, and a fourth through hole portion 51E. Each of the plurality of second through hole portions 51C is an example of a “first blow-out port”.

The plurality of first through hole portions 51B are positioned in a lower side portion of the opening portion 100B. The plurality of first through hole portions 51B form four columns. Each of the four first through hole portions 51B is constituted by six or seven through holes that are arranged in a row along the up-down direction. Two columns of the four first through hole portions 51B are positioned in a right side portion of the panel 51. The other two columns of the four first through hole portions 51B are positioned in a left side portion of the panel 51.

Hereinafter, the first through hole portion 51B positioned on the leftmost side among the four columns may be referred to as an “exhaust portion 51BB”. Further, the first through hole portion 51B positioned on the rightmost side among the four columns may be referred to as an “air intake portion 51BC”. Furthermore, the first through hole portions 51B other than the columns positioned on the leftmost side and the rightmost side among the four columns may be collectively referred to as “air intake portions 51BA”.

The plurality of second through hole portions 51C are positioned in an upper side portion of the opening portion 100B. The plurality of second through hole portions 51C are disposed in a row across from the right portion to the left portion of the panel 51. Further, the positions of lower ends 51Ca of the plurality of second through hole portions 51C are higher than the position of the upper surface 21C of the lid portion 21 of the pull-out body 2.

The pair of third through hole portions 51D include a right side through hole portion 51Da and a left side through hole portion 51Db. The right side through hole portion 51Da is positioned in a right side portion of the opening portion 100B. The left side through hole portion 51Db is positioned in a left side portion of the opening portion 100B. As a result, the right side slide member 241 is inserted into the right side through hole portion 51Da of the panel 51. The left side slide member 242 is inserted into the left side through hole portion 51Db of the panel 51.

The fourth through hole portion 51E is positioned in a lower side portion of the opening portion 100B and in a substantially center portion in the right-left direction. As a result, the support member 25 is inserted into the fourth through hole portion 51E of the panel 51.

Once again, as illustrated in FIG. 4 and FIG. 5, the pull-out type heating cooking apparatus 100 further includes a cooling fan 60. The cooling fan 60 is disposed outside the heating cooking chamber 100A. Specifically, the cooling fan 60 is disposed in the second space R2.

The cooling fan 60 takes air from outside of the pull-out type heating cooking apparatus 100 into the second space R2, and discharges air in the first space R1 to the outside of the pull-out type heating cooking apparatus 100. For example, the cooling fan 60 is a cross-flow fan. The cooling fan 60 is positioned in the second space R2 and at a rear portion. More specifically, the cooling fan 60 is positioned at the same height as the air intake portion 51BA of the panel 51.

Specifically, the cooling fan 60 includes a first cooling fan 61 and a second cooling fan 62. The first cooling fan 61 and the second cooling fan 62 face each other in the right-left direction.

Here, a flow of air generated by the drive of the first cooling fan 61 will be described. When the first cooling fan 61 is driven, an intake air flow AF is generated. The intake air flow AF flows from the outside of the pull-out type heating cooking apparatus 100 through the plurality of air intake portions 51BA, circulates through the second space R2 between the microwave supply unit 15 and the bottom outer wall 1F, and flows toward the first cooling fan 61. At this time, the intake air flow AF cools the antenna motor 154 of the microwave supply unit 15.

Further, when the first cooling fan 61 is driven, a blown air flow BF is generated. The blown air flow BF is blown out in the upward direction. The blown air flow BF circulates, in the upward direction, through the third space R3 between the first air sending unit 13 and the back outer wall 1K. At this time, the blown air flow BF cools the drive unit 133 of the first air sending unit 13.

The blown air flow BF having reached the top outer wall 1J circulates through the first space R1 between the top wall 1C of the heating cooking chamber 100A and the top outer wall 1J of the heating chamber 1. More specifically, the blown air flow BF circulates, in the forward direction, through the first space R1 between the second air sending unit 14 and the top outer wall 1J. At this time, the blown air flow BF cools the drive unit 143 of the second air sending unit 14.

The blown air flow BF having reached the panel 51 is discharged from the plurality of second through hole portions 51C of the panel 51, to the outside of the pull-out type heating cooking apparatus 100. In other words, the blown air flow BF is blown out from the plurality of second through hole portions 51C. The blown air flow BF includes first air. Specifically, the first air is the air that has cooled the drive unit 133 of the first air sending unit 13. The temperature of the first air of the blown air flow BF is higher than the temperature of the intake air flow AF. The blown air flow BF circulates in the forward direction.

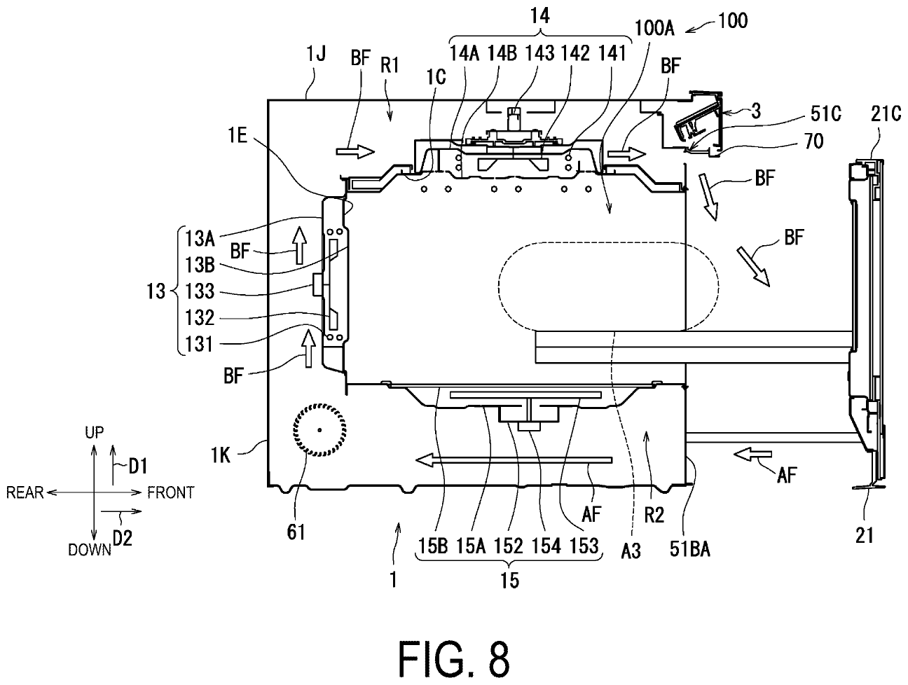

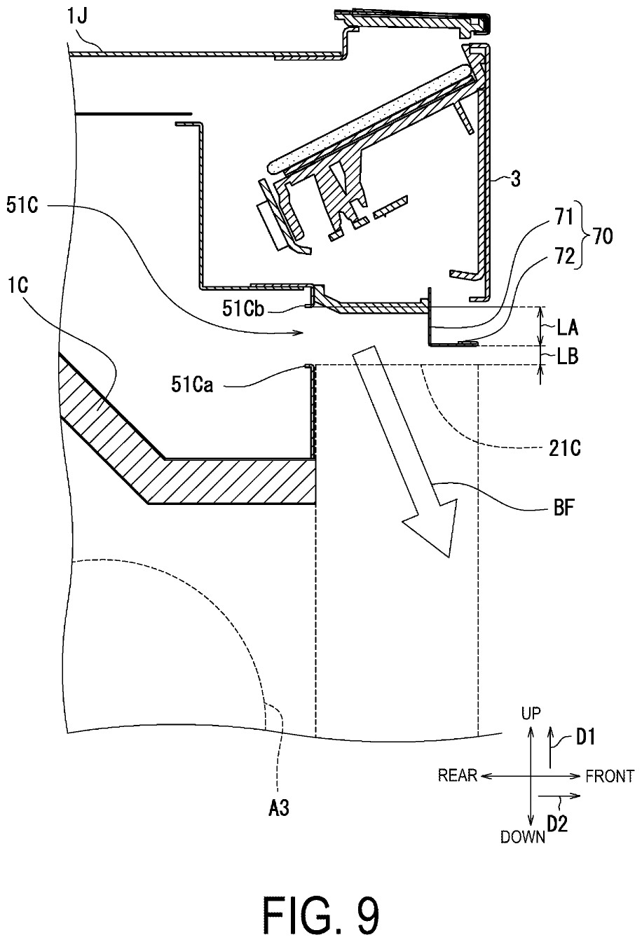

Further, next, the pull-out type heating cooking apparatus 100 in a state where the pull-out body 2 is pulled out will be described with reference to FIG. 8 and FIG. 9. FIG. 8 is a cross-sectional view illustrating the pull-out type heating cooking apparatus 100. FIG. 9 is an enlarged view illustrating the pull-out type heating cooking apparatus 100. As illustrated in FIG. 8 and FIG. 9, the pull-out type heating cooking apparatus 100 further includes the guide portion 70.

Specifically, the guide portion 70 includes a protruding portion 71. The guide portion 70 is disposed above the lid portion 21 in a state where the opening portion 100B is closed. The protruding portion 71 protrudes toward the upper surface 21C of the lid portion 21. Specifically, the protruding portion 71 is a plate-like member. The protruding portion 71 intersects the second direction D2. More specifically, the protruding portion 71 is disposed so as to be substantially perpendicular to the second direction D2. Further, the protruding portion 71 is disposed further in the second direction D2 than the plurality of second through hole portions 51C. Furthermore, the left end of the protruding portion 71 is positioned further to the left than the left end of the plurality of second through hole portions 51C. Further, the right end of the protruding portion 71 is positioned further to the right than the right end of the plurality of second through hole portions 51C. Furthermore, when viewed from the second direction D2, the area between the upper surface 21C of the lid portion 21 and the guide portion 70 is preferably substantially the same as the total area of the plurality of second through hole portions 51C that do not overlap the guide portion 70.

When the lid portion 21 closes the opening portion 100B, the blown air flow BF flows in the forward direction between the guide portion 70 and the upper surface 21C of the lid portion 21. On the other hand, when the lid portion 21 opens the opening portion 100B, the guide portion 70 guides the blown air flow BF blown out from the second through hole portions 51C, toward the opening portion 100B.

Here, a flow of air in a state where the lid portion 21 opens the opening portion 100B will be described. The blown air flow BF blown out from the plurality of second through hole portions 51C travels in the second direction D2. The blown air flow BF traveling in the second direction D2 reaches the guide portion 70. The guide portion 70 restricts the blown air flow BF from traveling in the second direction D2. For example, the blown air flow BF becomes a turbulent flow flowing downward and to the front.

On the other hand, third air A3 is present in the interior of the heating cooking chamber 100A. The third air A3 is the air heated by the microwaves, the heater 131, and the heater 141. The temperature of the third air A3 is higher than the temperature of the first air of the blown air flow BF. Further, the humidity of the third air A3 is higher than the humidity of the first air of the blown air flow BF. When the lid portion 21 moves in the second direction D2, the opening portion 100B is opened. As a result, the third air A3 moves from the opening portion 100B to the outside of the heating cooking chamber 100A. At this time, the blown air flow BF restricts the third air A3 from traveling in the upward direction.

As described above, with reference to FIG. 1 to FIG. 9, when the lid portion 21 opens the opening portion 100B, the guide portion 70 guides the blown air flow BF blown out from the second through hole portions 51C, toward the opening portion 100B. As a result, the blown air flow BF restricts the third air A3 from traveling in the upward direction. This can inhibit the third air A3 from flowing out in the upward direction from the interior of the heating cooking chamber 100A when the opening portion 100B is opened. As a result, it is possible to inhibit the air from flowing out toward the user who has opened the opening portion 100B of the heating cooking chamber 100A, and to suppress an unpleasant experience for the user.

Further, the pull-out type heating cooking apparatus 100 includes the pull-out body 2. It is possible to inhibit the third air A3 from flowing out in the upward direction when the pull-out body 2 is moved. As a result, it is possible to inhibit the air from flowing out toward the user, and to suppress the unpleasant experience for the user.

Furthermore, the protruding portion 71 protrudes toward the upper surface 21C of the lid portion 21. As a result, the blown air flow BF can be more effectively guided to the opening portion 100B side. This can more effectively inhibit the third air A3 from flowing out in the upward direction from the interior of the heating cooking chamber 100A when the opening portion 100B is opened.

More specifically, as illustrated in FIG. 9, the protruding portion 71 preferably protrudes to a position lower than a predetermined position. The predetermined position indicates an intermediate position between an upper end 51Cb and the lower end 51Ca of the second through hole portion 51C. More Specifically, the distance between the upper end 51Cb of the second through hole portion 51C and a lower end portion of the protruding portion 71 is a first distance LA. Further, the distance between the lower end portion of the protruding portion 71 and the lower end 51Ca of the second through hole portion 51C is a second distance LB. The first distance LA is greater than the second distance LB. As a result, the blown air flow BF can be more effectively guided to the opening portion 100B side. This can more effectively inhibit the third air A3 from being blown out in the upward direction from the interior of the heating cooking chamber 100A when the opening portion 100B is opened.

Once again, as illustrated in FIG. 4, the pull-out type heating cooking apparatus 100 further includes a duct member 30. The duct member 30 is disposed outside the heating cooking chamber 100A.

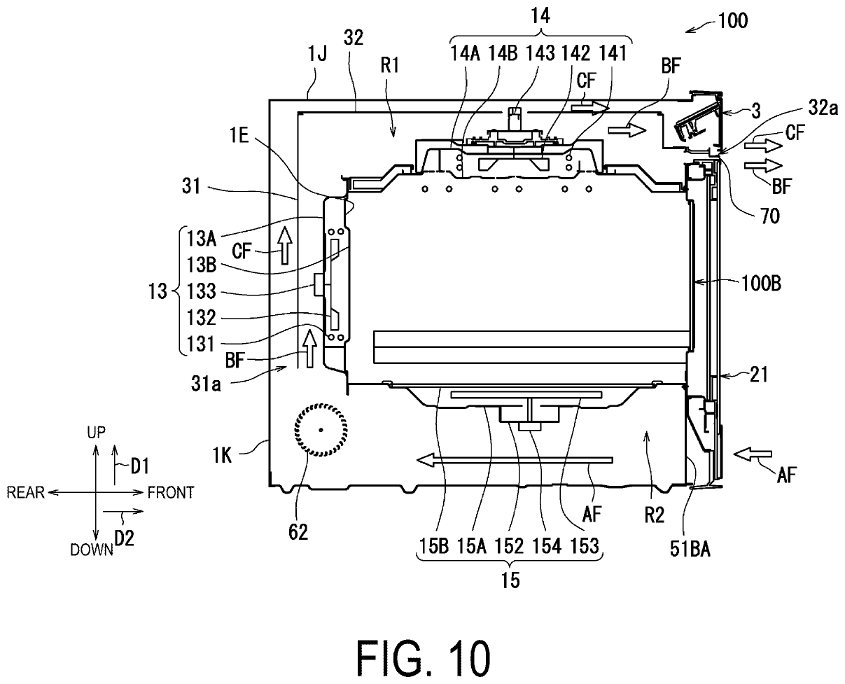

The duct member 30 will be described with reference to FIG. 4 and FIG. 10. FIG. 10 is a diagram illustrating a schematic cross-section of the heating chamber 1. More specifically, FIG. 10 is a cross-sectional view of the pull-out type heating cooking apparatus 100 taken along a section line X in FIG. 4.

As illustrated in FIG. 4 and FIG. 10, the duct member 23 includes a first groove portion 31 and a second groove portion 32. The second groove portion 32 is an example of a “second circulation portion”. Specifically, the first groove portion 31 is disposed in the third space R3. The second groove portion 32 is disposed in the first space R1.

The first groove portion 31 is a portion having a groove shape and having a substantially U-like shape in cross-section with a longitudinal direction thereof corresponding to the up-down direction. The first groove portion 31 faces the back outer wall 1K. The first groove portion 31 is not in contact with the first air sending unit 13.

More specifically, the first groove portion 31 includes a suction port 31a. The suction port 31a opens in the direction opposite to the first direction D1. The suction port 31a is positioned above the second cooling fan 62. The suction port 31a is positioned in close proximity to the second cooling fan 62.

When the second cooling fan 62 is driven, the intake air flow AF is generated. The intake air flow AF flows from the outside of the pull-out type heating cooking apparatus 100 through the plurality of air intake portions 51BA, circulates through the second space R2 between the microwave supply unit 15 and the bottom outer wall 1F, and flows toward the second cooling fan 62.

Further, when the second cooling fan 62 is driven, a blown air flow CF is generated. The blown air flow CF is blown out in the upward direction. The blown air flow CF is introduced between the first groove portion 31 and the back outer wall 1K via the suction port 31a, and circulates, in the upward direction, between the first groove portion 31 and the back outer wall 1K.

The second groove portion 32 is a portion having a groove shape and having a substantially U-like shape in cross-section with a longitudinal direction thereof corresponding to a direction intersecting the front-rear direction. The second groove portion 32 faces the top outer wall 1J. The second groove portion 32 is not in contact with the second air sending unit 14.

The second groove portion 32 is coupled to the first groove portion 31. The blown air flow CF flowing between the first groove portion 31 and the back outer wall 1K circulates between the second groove portion 32 and the top outer wall 1J. In other words, the second groove portion 32 causes the blown air flow CF to circulate between the top wall 1C of the heating cooking chamber 100A and the top outer wall 1J of the heating chamber 1, above the first circulation portion through which the blown air flow BF circulates. The blown air flow CF includes second air. The temperature of the second air of the blown air flow CF is lower than the temperature of the first air of the blown air flow BF.

The second groove portion 32 includes a blow-out port 32a. The blow-out port 32a is an example of a “second blow-out port”. The blow-out port 32a opens toward the second direction D2. The blown air flow CF is discharged from the blow-out port 32a to the outside of the pull-out type heating cooking apparatus 100. The blown air flow CF circulates in the forward direction.

At least a part of the operation panel 3 is disposed in the second groove portion 32. As a result, the blown air flow CF can cool the operation panel 3.

More specifically, preferably, the guide portion 70 further includes an extending portion 72. The extending portion 72 extends from the lower end portion of the protruding portion 71 along the upper surface 21C of the lid portion 21 in a state where the opening portion 100B is closed. Specifically, the extending portion 72 is a plate-like member. The extending portion 72 intersects the first direction D1. More specifically, the extending portion 72 is disposed so as to be substantially perpendicular to the first direction D1. Further, the extending portion 72 is disposed further in the second direction D2 than the protruding portion 71. As a result, the extending portion 72 can restrict the blown air flow BF from traveling toward a position higher than the second through hole portion 51C. Thus, the temperature of the operation panel 3 can be inhibited from rising due to the blown air flow BF.

Once again, as illustrated in FIG. 5, the pull-out type heating cooking apparatus 100 further includes a grill unit 16.

Specifically, the grill unit 16 includes a heater 161 and an energization unit 162. The heater 161 is positioned in the heating cooking chamber 100A and heats the object H to be heated. Specifically, the heater 161 is positioned at an upper portion in the heating cooking chamber 100A. The heater 161 is substantially U-shaped when viewed in the vertical direction. In the present embodiment, three of the grill units 16 are disposed. The heater 161 is, for example, a sheathed heater. The energization unit 162 is positioned outside the heating cooking chamber 100A. The energization unit 162 energizes the heater 161. The energized heater 161 generates heat.

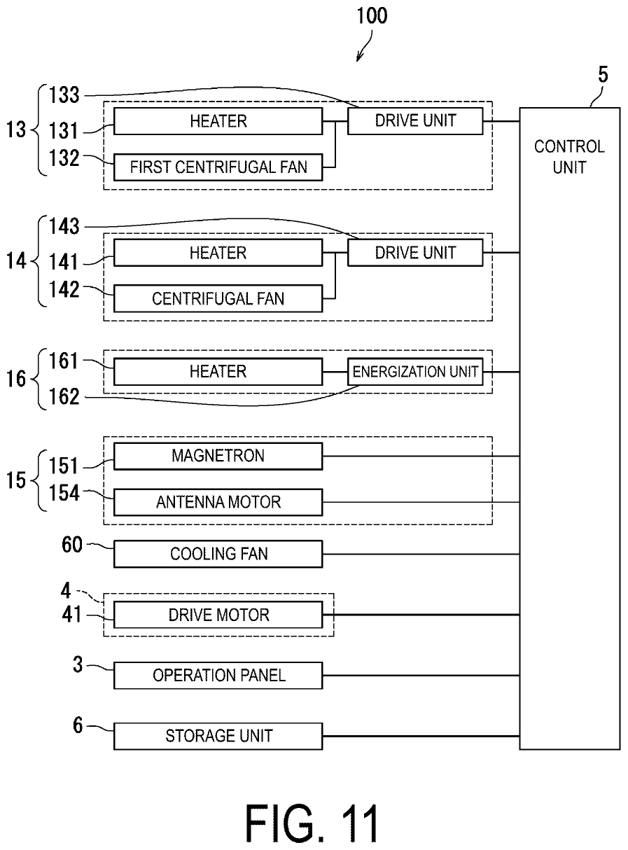

Next, a configuration of the pull-out type heating cooking apparatus 100 will be described in detail with reference to FIG. 11. FIG. 11 is a block diagram illustrating the configuration of the pull-out type heating cooking apparatus 100. In the present embodiment, the pull-out type heating cooking apparatus 100 has a “microwave heating mode,” a “hot air circulation heating mode,” and a “grill heating mode” as heating cooking modes. The “microwave heating mode” is mainly a mode in which the object H to be heated is heated and cooked by radiating microwaves into the heating cooking chamber 100A. The “grill heating mode” is mainly a mode in which the object H to be heated is heated and cooked by conducting the heat generated by the heater 161 to the object H to be heated. The “hot air circulation heating mode” is mainly a mode in which the object H to be heated is heated and cooked by circulating hot air in the heating cooking chamber 100A to make the temperature in the heating cooking chamber 100A uniform.

By executing the control program stored in the storage unit 6, the control unit 5 controls a magnetron 151, the antenna motor 154, the energization unit 162, the drive motor 41, the operation panel 3, the cooling fan 60, the drive unit 133, the drive unit 143, and the storage unit 6.

More specifically, the control unit 5 controls driving of the microwave supply unit 15, driving of the first air sending unit 13, driving of the second air sending unit 14, and driving of the grill unit 16. For example, in a case where the “microwave heating mode” is selected, the control unit 5 drives the cooling fan 60, the magnetron 151, and the antenna motor 154. Further, in a case where the “grill heating mode” is selected, the control unit 5 drives the cooling fan 60 and the energization unit 162. Furthermore, in a case where the “hot air circulation heating mode” is selected, the control unit 5 drives the cooling fan 60, the drive unit 133, and the drive unit 143.

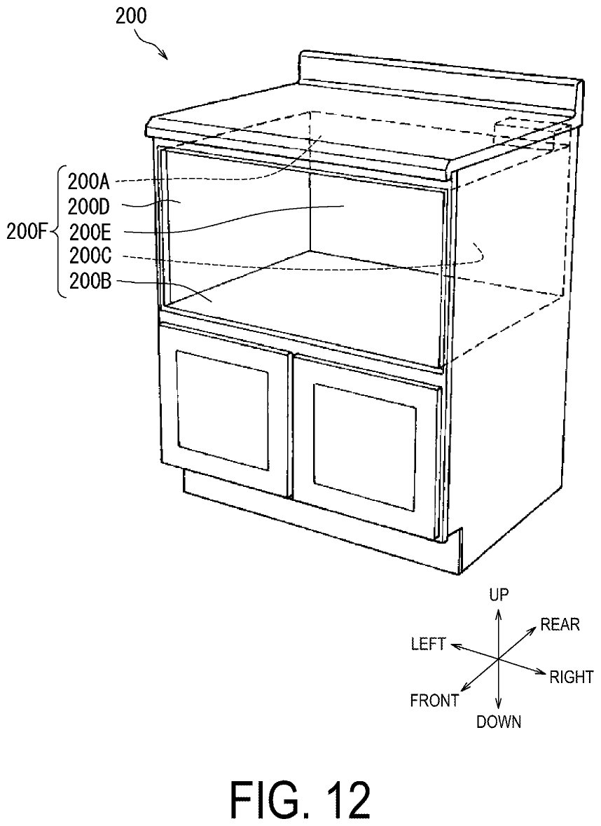

Next, a cabinet 200 to which the pull-out type heating cooking apparatus 100 is attached will be described with reference to FIG. 12. FIG. 12 is a perspective view illustrating the cabinet 200 to which the pull-out type heating cooking apparatus 100 is attached.

As illustrated in FIG. 12, the pull-out type heating cooking apparatus 100 is attached to and installed in the cabinet 200. The cabinet 200 includes an upper wall 200A, a lower wall 200B, a right wall 200C, a left wall 200D, and a rear wall 200E. The upper wall 200A, the lower wall 200B, the right wall 200C, the left wall 200D, and the rear wall 200E form an accommodation portion 200F. The accommodation portion 200F is a rectangular parallelepiped space into which the pull-out type heating cooking apparatus 100 is fitted.

The embodiment of the present invention has been described above with reference to the accompanying drawings. However, the present invention is not limited to the embodiment described above, and the present invention can be implemented in various modes without departing from the gist thereof. The drawings primarily schematically illustrate each of the constituent elements for the sake of easier understanding, and the thickness, length, quantity, and the like of each of the illustrated constituent elements are different from the actual thickness, length, quantity, and the like by reason of creation of the drawings. Further, the material, shape, dimensions, and the like of each of the constituent elements illustrated in the embodiment described above are merely examples and are not particularly limited, and various modifications can be made within the scope not substantially departing from the effects of the present invention.

As described with reference to FIG. 1 to FIG. 12, the pull-out type heating cooking apparatus 100 includes the heating chamber 1 and the pull-out body 2 including the lid portion 21, but the present invention is not limited thereto. For example, the lid portion 21 may be an opening/closing door including a rotating shaft.

### INDUSTRIAL APPLICABILITY

The present invention provides a heating cooking apparatus, and the provided heating cooking apparatus has industrial applicability.

### REFERENCE SIGNS LIST

1 Heating chamber (housing)
1C Top wall (upper wall)
1J Top outer wall (upper wall)
21 Lid portion
51C Second through hole portion (first blow-out port)
70 Guide portion
100 Pull-out type heating cooking apparatus
100A Heating cooking chamber
100B Opening portion (opening)
BF Blown air flow (first air)
R1 First space (first circulation portion)

1. A heating cooking apparatus comprising:
a heating cooking chamber including an opening;
a housing accommodating the heating cooking chamber;
a lid portion configured to open and close the opening;
a first circulation portion configured to cause first air to circulate between an upper wall of the heating cooking chamber and an upper wall of the housing;
a first blow-out port from which the first air is blown out; and
a guide portion configured to guide, toward the opening, the first air blown out from the first blow-out port when the lid portion opens the opening.

2. The heating cooking apparatus according to claim 1, further comprising:
a heating unit configured to heat an object to be heated accommodated in the heating cooking chamber,
wherein the heating unit includes
a heating element, and
a contributing portion configured to contribute to the heating element, and
the contributing portion is disposed in the first circulation portion.

3. The heating cooking apparatus according to claim 1,
wherein the guide portion is disposed above the lid portion in a state where the opening is closed, and includes a protruding portion protruding toward an upper surface of the lid portion.

4. The heating cooking apparatus according to claim 3,
wherein the protruding portion protrudes to a position lower than a predetermined position, and
the predetermined position indicates an intermediate position between an upper end and a lower end of the first blow-out port.

5. The heating cooking apparatus according to claim 3,
wherein the guide portion further includes an extending portion extending from a lower end portion of the protruding portion along the upper surface of the lid portion in the state where the opening is closed.

6. The heating cooking apparatus according to claim 1, further comprising:
a second circulation portion including a second blow-out port from which second air is blown out, and configured to cause the second air to circulate above the first circulation portion and between the upper wall of the heating cooking chamber and the upper wall of the housing; and
an operation unit configured to receive an operation,
wherein at least a part of the operation unit is disposed in the second circulation portion.

7. The heating cooking apparatus according to claim 1, further comprising:
a moving member configured to move along a specific direction with respect to the heating cooking chamber,
wherein the opening opens toward the specific direction, and
the lid portion is fixed to the moving member to be substantially perpendicular to the specific direction.
